(19) United States
(12) Patent Application Publication
(10) Pub. No.: US 2024/0164531 A1
(43) Pub. Date: May 23, 2024

(54) TWO-STAGE FOOT SUPPORT DEVICE

(71) Applicant: Sang Su PARK, Gwangju (KR)

(72) Inventor: Sang Su PARK, Gwangju (KR)

(21) Appl. No.: 18/552,319

(22) PCT Filed: Mar. 24, 2022
(86) PCT No.: PCT/KR2022/004140

§ 371 Date: Sep. 25, 2023

(30) Foreign Application Priority Data
Mar. 25, 2021 (KR) 10-2021-0038771

(51) Int. Cl. A47C 16/02

(52) U.S. Cl. CPC A47C 16/025

(57) ABSTRACT

The present invention relates to a two-stage foot support device, which is located in front of a chair under a desk or various tables, to allow a user to place a foot or calf on the device and work or take a rest with a comfortable posture, and the device comprises: a lower footboard support means having a lower footboard which is fixed thereto and on which the user's foot is placed; and an upper footboard support means positioned above the lower footboard support means and having an upper footboard which is fixed thereto and on which the user's foot or calf is placed, wherein the upper and the lower footboard are installed to be rotatable from the upper and the lower footboard support means, respectively, so that the upper and the lower footboard can be selectively folded or unfolded for use.

### TECHNICAL FIELD

The present disclosure relates to a two-stage foot support device located in front of a chair under a desk or a variety of tables to allow a user to place his/her feet or calves on the device so as to work or take a rest in a comfortable position.

### BACKGROUND ART

A foot support device for a desk is located in front of a chair under a desk or a variety of tables to allow a user seated on the chair or working at the desk or a table to place his/her feet or calves on the device so as to work or take a rest in a comfortable position. As a related-art technology of the foot support device for a desk, a multi-function two-stage foot support is disclosed in Korean Registered Utility Model No. 20-0478240 as illustrated in FIG. 1, and is configured as below:
-Below-
a pair of sidewalls 100 having the shape of a plate;
lower fitting grooves 200 depressed into the lower portions of the inner surfaces of the sidewalls;
upper fitting grooves 300 depressed into the upper portions of the inner surfaces of the sidewalls to be shorter than the lower fitting grooves;
bolt holes H formed in the lower and upper fitting grooves to be adjacent to both ends of the lower and upper fitting grooves, respectively;
a pair of lower fixed plates 400 with both ends thereof being fitted into the both ends of the lower fitting grooves, respectively, and fastened to the lower fitting grooves via the bolt holes;
at least one lower middle plate 500 disposed between the lower fixed plates, with both ends thereof being fitted into the lower fitting grooves;
a pair of upper fixed plates 600 with both ends thereof being fitted into the both ends of the upper fitting grooves, respectively, and fastened to the upper fitting grooves via the bolt holes;
at least one upper middle plate 700 disposed between the upper fixed plates, with both ends thereof being fitted into the upper fitting grooves; and
a plurality of bolts B fitted into the bolt holes, respectively, to be fastened with the ends of the lower fixed plates and the ends of the upper fixed plates, respectively.

In addition, another related-art technology of the foot support device for a desk, Korean Registered Utility Model No. 20-0438341 as illustrated in FIG. 2 is disclosed, and is configured as below:
-Below-
a foot support 100 including a plurality of acupressure protrusions C on the top surface, an accommodating portion 110 provided inside the bottom, slits 120 provided in both side surfaces and respectively having a plurality of catching depressions 121, and catching protrusions 130 respectively provided at one side of the slits;
a leg support 200 including a leg support member 210, wherein a seating recess 212 is formed in the central portion of the top of the leg support member in the longitudinal direction and catching protrusions 211 are formed on both side surfaces of the leg support member, elastic bars 211 pivotably fastened to both sides of the bottom of the leg support member 210 and configured to be fastened to the catching depressions 121 of the slits 120 of the foot support 100, pivot members 221 respectively having slide holes 221a in one side, and a massage rod 220 having a plurality of acupressure protrusions C and pivotably fastened to the pivot members 221; and
a leg exercise part 300 including pivot supports 310 pivotably fastened to both side portions of the foot support 100 and a rollable acupressure rod 320 provided between the pivot supports 310.

Korean Registered Utility Model Nos. 20-0478240 and 20-0438341 having the above-described configurations according to the related art may not be efficiently used, since the angle of each support is not adjustable.

### DISCLOSURE

### Technical Problem

Accordingly, objectives of a two-stage foot support device according to the present disclosure are as follows.

First, the two-stage foot support device may be located in front of a chair under a desk or a variety of tables to allow a user to place his/her feet or calves on the device so as to work or take a rest in a comfortable position.

Second, the angle of an upper or lower footrest may be adjusted as required to an angle at which the user may feel comfortable.

Third, when the upper footrest is not used, the upper footrest may be folded upwards, and the upper footrest may be continuously maintained in the folded position so as not to be accidently unfolded from the folded position.

Fourth, the upper and lower footrests may be provided on the upper and lower footrest support means, respectively, so as to be selectively used.

### Technical Solution

In order to accomplish at least one of the above objectives, as a technical solution of the present disclosure, provided is a two-stage foot support device.

The two-stage foot support device is located on an indoor floor in front of a chair under a desk or a table to allow a user to place his/her feet or calves on the device so as to work or take a rest in a comfortable position. The two-stage foot support device may include: a lower footrest support means provided at a lower position, with a lower footrest being disposed thereon; and an upper footrest support means provided above the lower footrest support means, with an upper footrest being disposed thereon.

The lower footrest support means (10) may have an “L” shaped cross-section when viewed from a side, braces (31) are pivotably disposed on both sides of a bottom of the L-shaped lower footrest support means, the lower footrest (30) having a slope inclined downward from the rear to the front is disposed on the braces, thereby allowing the feet to be comfortably placed on the lower footrest and the lower footrest to be folded or unfolded for use. The lower footrest support means (10) may include lower footrest fixing portions (11) inclined downward in a top to bottom direction and lower coupling portions (12) provided on both rear ends of the lower footrest fixing portions to extend upward such that the lower footrest is prevented from being accidently unfolded once folded upwards.

The upper footrest support means (20) may be shaped as “U” when viewed from above and the Korean letter “¬” when viewed from a side. An upper footrest (40) may be pivotably disposed on the U-shaped top of the upper footrest support means so that the upper footrest is foldable or unfoldable for use, and may include an upper footrest fixing portion (21) inclined downward in a top to bottom direction and upper coupling portions (22) provided on both the rear ends of the upper footrest fixing portion to extend upward such that the upper footrest is prevented from being accidently unfolded once folded upwards.

### Advantageous Effects

As described above in the Technical Problem section, the two-stage foot support device having the above-described configuration according to the present disclosure may be located in front of a chair under a desk or a variety of tables to allow a user to place his/her feet or calves on the device so as to work or take a rest in a comfortable position. The angle of an upper or lower footrest may be adjusted as required to an angle at which the user may feel comfortable. When the upper footrest is not used, the upper footrest may be folded upwards, and the upper footrest may be continuously maintained in the folded position so as not to be accidently unfolded from the folded position. In addition, the upper and lower footrests may be provided on the upper and lower footrest support means, respectively, so as to be selectively used.

### DESCRIPTION OF DRAWINGS

FIG. 1 is an exploded perspective view illustrating a foot support device according to a first example of the related art;

FIG. 2 is an exploded perspective view illustrating a foot support device according to a second example of the related art;

FIG. 3 is a bottom perspective view illustrating a two-stage foot support device according to the present disclosure;

FIG. 4 is a side view illustrating the two-stage foot support device according to the present disclosure;

FIGS. 5a and 5b are perspective views illustrating embodiments of the upper and lower footrest supporting means according to the present disclosure;

FIGS. 6a to 6c are extracted perspective views illustrating embodiments of the lower footrest according to the present disclosure;

FIGS. 7a to 7d are extracted perspective views illustrating embodiments of the lower footrest pivoting means according to the present disclosure;

FIGS. 8a to 8c are extracted perspective views illustrating embodiments of the upper footrest angle changing means of the upper footrest according to the present disclosure; and

FIG. 9 is a perspective view illustrating the two-stage foot support device according to the present disclosure in which the upper and lower footrests are folded.

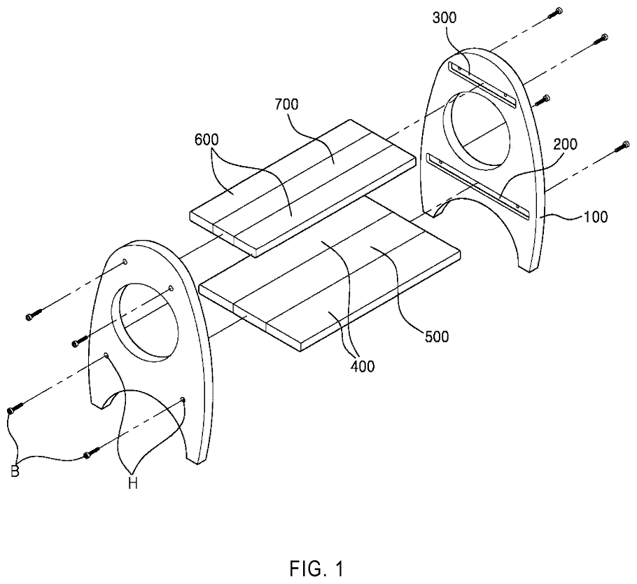

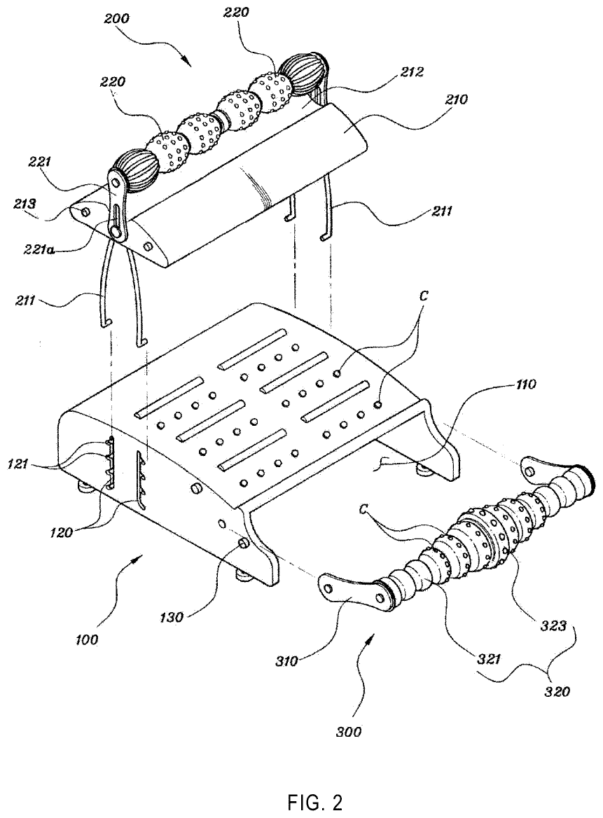

### BEST MODE

The present disclosure relates to a two-stage foot support device located in front of a chair under a desk or a variety of tables to allow a user to place his/her feet or calves on the device so as to work or take a rest in a comfortable position, and embodiments thereof will be described hereinafter with reference to the accompanying drawings.
-Below-

Provided is a two-stage foot support device located on an indoor floor in front of a chair under a desk or a table to allow a user to place his/her feet or calves on the device so as to work or take a rest in a comfortable position. The two-stage foot support device includes a lower footrest support means provided at a lower position, with a lower footrest being disposed thereon, and an upper footrest support means provided above (or on) the lower footrest support means, with an upper footrest being disposed thereon.

The lower footrest support means 10 has an “L” shaped cross-section when viewed from the side. Braces 31 are pivotably disposed on both sides of the bottom of the L-shaped lower footrest support means. A lower footrest 30 having a slope inclined downward from the rear to the front is disposed on the braces. Thus, the feet (or a foot) may be comfortably placed on the lower footrest, and the lower footrest may be folded or unfolded for use. The lower footrest support means 10 includes lower footrest fixing portions 11 inclined downward in the top to bottom direction and lower coupling portions 12 provided on both the rear ends of the lower footrest fixing portions to extend upward. This configuration prevents the lower footrest from being accidently unfolded once folded upwards.

The upper footrest support means 20 has the shape of the letter “U” when viewed from above and the Korean letter “¬” when viewed from the side. An upper footrest 40 is pivotably disposed on the U-shaped top of the upper footrest support means so that the upper footrest may be folded or unfolded for use. The upper footrest support means includes an upper footrest fixing portion 21 inclined downward in the top to bottom direction and upper coupling portions 22 provided on both the rear ends of the upper footrest fixing portion to extend upward. This configuration prevents the upper footrest from being accidently unfolded once folded upwards.

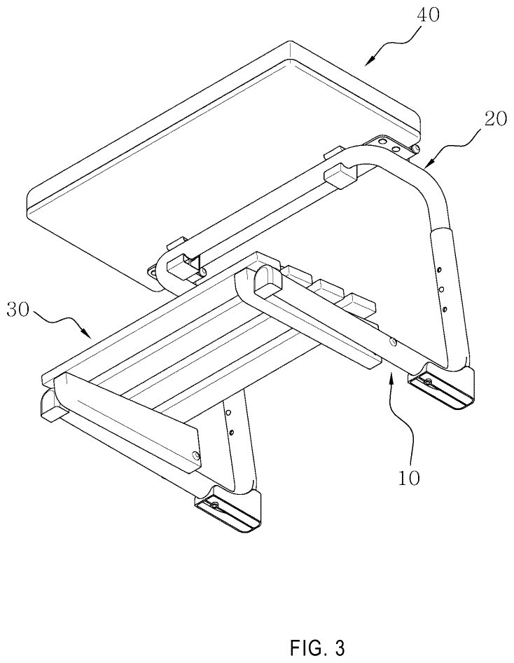

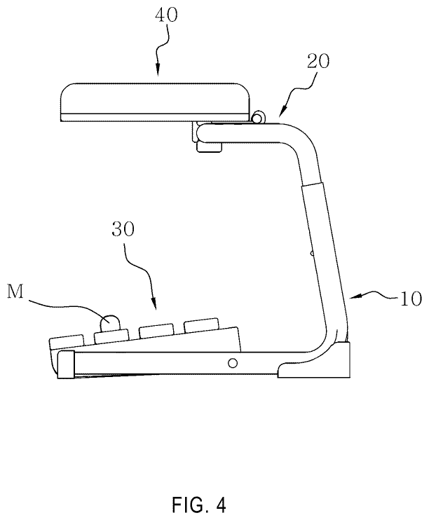

The two-stage foot support device having the above-described configuration according to the present disclosure is located on the indoor floor in front of a chair under a desk or a table to be used. As illustrated in FIGS. 3 and 4, the lower and upper footrests 30 and 40 are spaced apart from each other a predetermined distance. Thus, the user seated on the chair may place the feet on the lower footrest 30 or place his/her feet or calves on the upper footrest 40 to work or take a rest in a comfortable position.

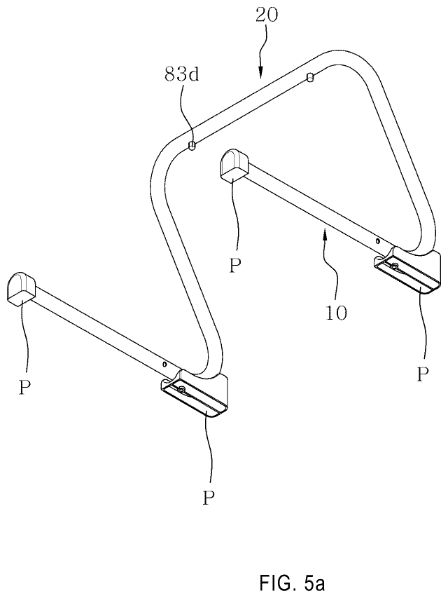

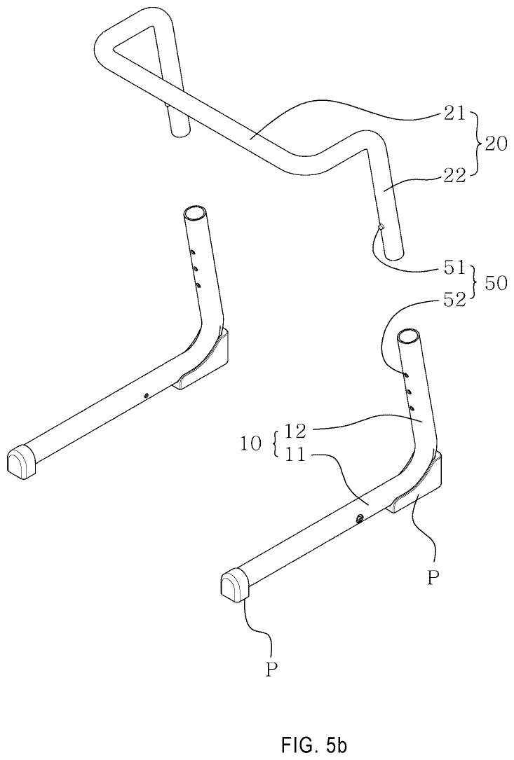

The lower and upper footrest support means 10 and 20 on which the lower and upper footrests 30 and 40 are disposed, respectively, may be configured as being integrally connected to each other as illustrated in FIG. 5a. Alternatively, as illustrated in FIG. 5b, the lower and upper footrest support means 10 and 20 may be configured to be detachably connected to each other. Thus, the upper footrest support means 20 on which the upper footrest 40 is disposed may be height adjusted with respect to the lower footrest support means 10 on which the lower footrest 30 is disposed, thereby adjusting the distance between the lower and upper footrests 30 and 40.

The distance between the lower and upper footrests 30 and 40 is adjusted as above in order to change the distance between the lower and upper footrests 30 and 40 depending on the physical condition of the user, i.e., the length of the feet, thereby allowing the user to locate and use the lower and upper footrests 30 and 40 at the most comfortable position.

In addition, as described above, each of the lower and upper footrest support means 10 and 20 on which the lower and upper footrests 30 and 40 are disposed, respectively, may be implemented using a hollow frame having the shape of a circular or angled pipe. Alternatively, the lower and upper footrest support means 10 and 20 may be implemented using any structures that allow the lower and upper footrests 30 and 40 to be disposed thereon and the heights of the lower and upper footrests 30 and 40 disposed thereon to be adjusted.

The lower and upper footrest support means 10 and 20 are implemented using hollow frames each having the shape of a circular or angled pipe for the following reasons. When the lower and upper footrest support means 10 and 20 are integrally connected to each other, the connecting portion between the lower and upper footrest fixing portions 11 and 21 and the connecting portion between the lower and upper coupling portions 12 and 22 may be easily bent and deformed. When the lower and upper footrest support means 10 and 20 are configured to be detachably connected to each other, the heights of the lower and upper footrest fixing portions 11 and 21 may be easily adjusted.

In addition, as illustrated in FIG. 5b, in the lower footrest support means 10, the lower footrest fixing portions 11 on which the lower footrest 30 is disposed are located on both sides of the lower part to maintain a predetermined distance, and the lower coupling portions 12 extend upward from the rear ends of the lower footrest fixing portions 11, respectively. With this configuration, the lower footrest 30 may be placed on the lower footrest fixing portions 11, and the lower coupling portions 12 may be fitted around the upper coupling portions 22 described below, respectively.

In addition, the upper footrest fixing portion 21 on which the upper footrest 40 is disposed is provided in the upper portion of the upper footrest support means 20. The upper coupling portions 22 are provided on the rear ends of both sides of the upper footrest fixing portion 21 to extend downward to be coupled to the lower coupling portions 12. The upper footrest 40 is placed on the upper footrest fixing portion 21. The upper coupling portions 22 are fitted into the above-described lower coupling portions 12.

The lower footrest support means 10 including the lower footrest fixing portions 11 and the lower coupling portions 12 may have the shape of the letter “L”. The upper footrest support means 20 including the upper footrest fixing portion 21 and the upper coupling portions 22 may have the shape of the Korean letter “¬” when viewed from the side. The upper leading end of the “¬” shape may have the shape of the hyphen “-” or the letter “U”.

In addition, when the upper footrest fixing portion 21 is U-shaped, in a position in which the upper footrest 40 is folded upwards as illustrated in FIG. 9, the feet may be placed on the U-shaped upper footrest fixing portion 21.

In addition, the lower and upper footrest support means 10 and 20 are configured to be height adjustable. In the height adjustable configuration, the lower coupling portions 12 of the lower footrest support means 10 and the upper coupling portions 22 of the upper footrest support means 20 are fitted to each other in a slidable manner. In the fitted state, after the height adjustment, the adjusted height is fixed using a fixing means 50 so that the height does not change.

The fixing means 50 is configured such that a stopper 51 is provided on each of the lower or upper coupling portions 12 or 22 and holes 52 are provided in each of the upper or lower coupling portions 22 or 12 in the longitudinal direction, as illustrated in FIG. 5b. When the stopper 51 is aligned with one of the holes 52, the stopper 51 is fitted into the hole 52.

The fixing means 50 as described above is an embodiment of the present disclosure, and may have any configuration that fixes the height of the lower and upper footrest support means 10 and 20 after the height is fixed.

In addition, as illustrated in FIGS. 5a and 5b, protection members P are disposed on the bottom of the lower footrest support means 10 according to the present disclosure. The tops of the protection members P are coupled to the lower footrest fixing portions 11, respectively, and the bottoms of the protection members P are supported on the indoor floor. Thus, the protection members P are in contact with the indoor floor to prevent direct contact between the lower footrest fixing portions 11 and the indoor floor, thereby preventing friction noise between the lower footrest fixing portions 11 and the indoor floor and protecting the lower footrest support means 10.

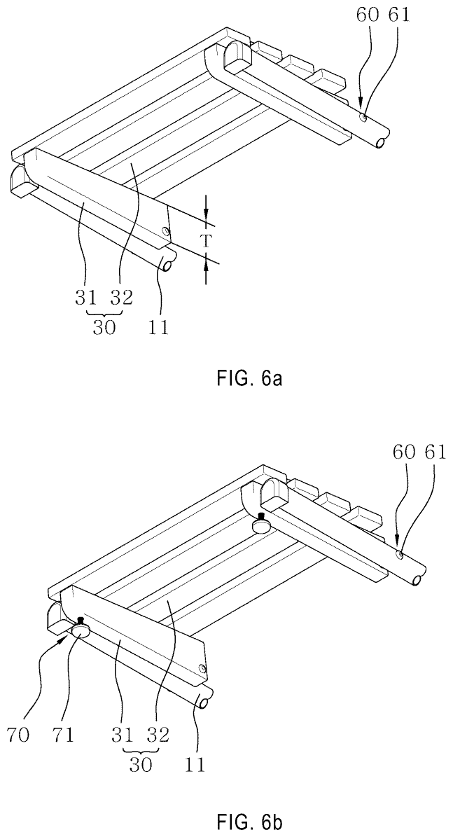

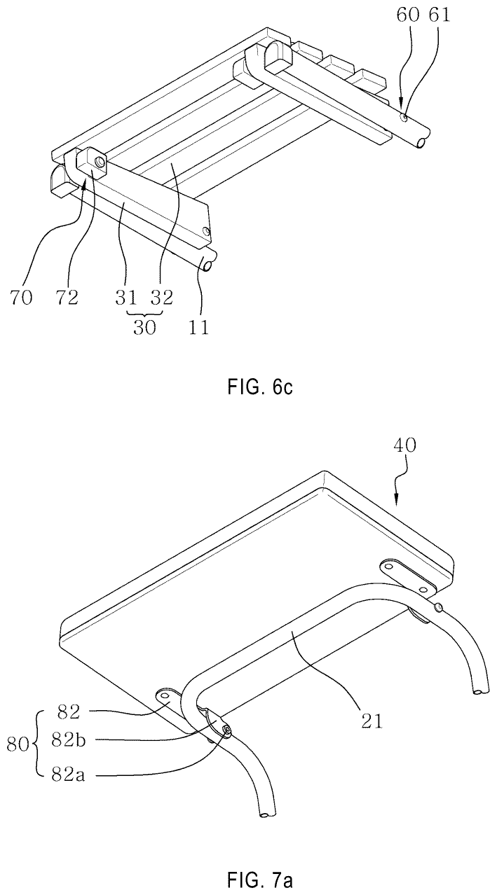

In addition, as illustrated in FIG. 6a, the lower footrest 30 according to the present disclosure may include the braces 31 fixed to the lower footrest support means 10 and a plurality of horizontal bars 32 disposed on the braces and spaced apart from each other predetermined distances. The lower footrest 30 may have any configuration on which the feet may be placed.

In addition, the lower footrest 30 is configured such that the lower footrest 30 may be pivoted and folded upwards as illustrated in FIG. 9 when not used and be returned from the folded position to the original position as illustrated in FIGS. 3 and 4 when used.

The lower footrest 30 operating as above is configured such that the thickness T of each of the braces 31 of the lower footrest 30 gradually decreases from the rear end on which the lower coupling portions 12 are located to the front facing the chair as illustrated in FIG. 6a, such that the surface of the lower footrest 30 has a slope inclined downward from the rear to the front. Thus, the user may place the feet on the lower footrest 30 comfortably.

In addition, as illustrated in FIGS. 6a to 6c, the pivoting of the lower footrest 30 according to the present disclosure is enabled by a lower footrest pivoting means 60 connecting the lower footrest fixing portions 11 of the lower footrest support means 10 and the lower footrest 30.

An embodiment of the configuration of the lower footrest pivoting means 60 is implemented as center pins 61 extending through the lower footrest 30 and the lower footrest fixing portions 11. When the lower footrest 30 is pivoted, the lower footrest 30 is pivoted about the center pins 61 to be folded upwards as illustrated in FIG. 9.

In addition, a lower footrest angle changing means 70 is disposed on the lower portion of the lower footrest 30. The lower footrest angle changing means 70 allows the angle of the lower footrest 30 with respect to the lower footrest fixing portions 11 to be changed. This configuration is intended to maintain the optimum angle depending on the body condition of the user so that the user may place the feet on the lower footrest in the most comfortable position while being seated on the chair.

As illustrated in FIG. 6b, a first embodiment of the lower footrest angle changing means 70 is configured such that lower screw bolts 71 are disposed on the front lower portions of the braces 31. Due to this configuration, the distances of the front portions of the lower footrest fixing portions 11 from the indoor floor vary depending on the directions of rotation of the lower screw bolts 71 so as to change the inclination of the lower footrest 30, thereby adjusting the top surface slope of the lower footrest 30.

As illustrated in FIG. 6c, a second embodiment of the lower footrest angle changing means 70 is configured such that polygonal lower eccentric rotation members 72 are rotatably disposed on the front side portions of the braces 31 of the lower footrest 30. The polygonal lower eccentric rotation members 72 are configured to rotate by means of center axes, respectively. The distances from the front portions of the lower footrest fixing portions 11 to the indoor floor change depending on the directions of the lower eccentric rotation members 72 so as to change the inclination of the lower footrest 30, thereby adjusting the top surface slope of the lower footrest 30.

The polygonal lower eccentric rotation members 72 are provided such that, in a position in which the lower eccentric rotation members 72 are rotated, the top surfaces of the rotated lower eccentric rotation members 72 and the lower surface of the lower footrest 30 are in surface contact to realize stable support force.

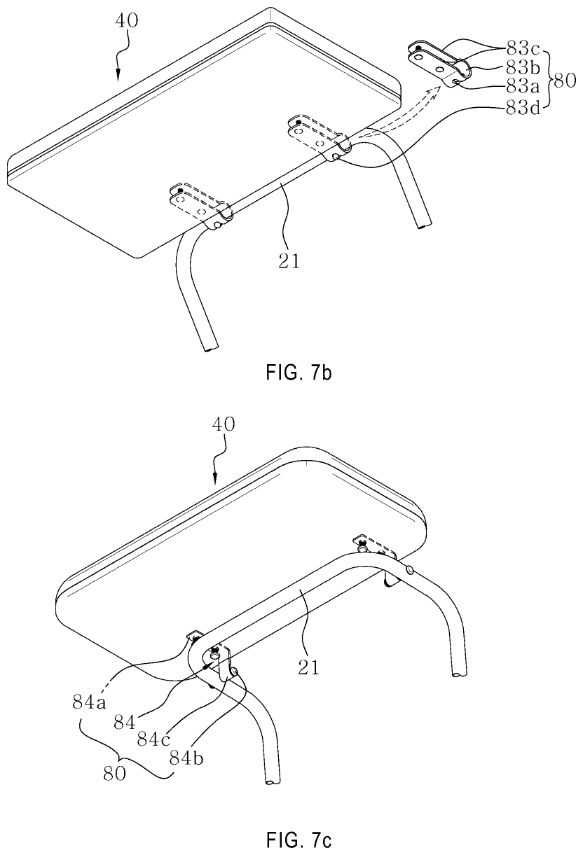

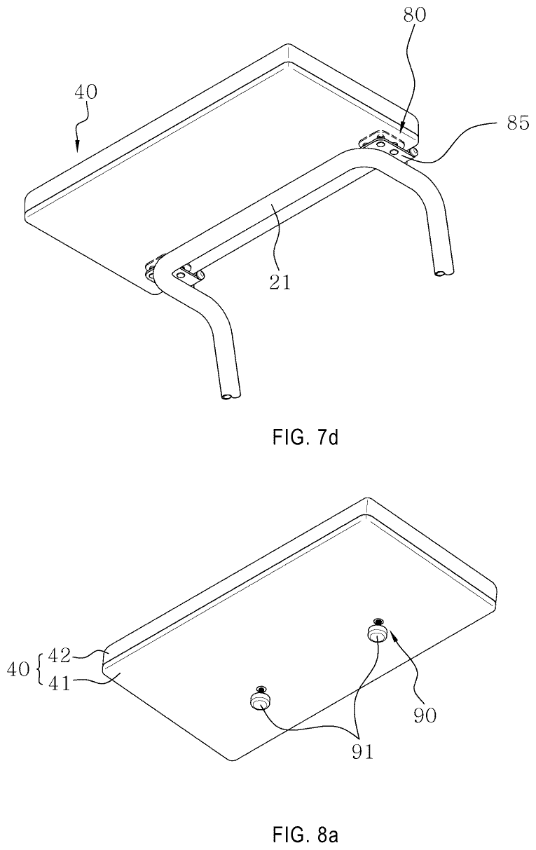

In addition, as illustrated in FIGS. 7a to 7d, for the upper footrest 40 according to the present disclosure, an upper footrest pivoting means 80 for pivoting the upper footrest is provided between the upper footrest support means 20 and the upper footrest 40. Thus, as illustrated in FIG. 9, the upper footrest 40 may be pivoted and folded upwards.

The upper footrest 40 described above and below being folded upwards indicates that the upper footrest 40 is reclined upward.

In addition, as illustrated in FIG. 7a, a first embodiment of the upper footrest pivoting means 80 according to the present disclosure is implemented as connectors 82 respectively including a connecting portion 82b with one side thereof being fixed to the upper footrest 40 and the other side thereof being pivotably disposed on the upper footrest fixing portion 21 by means of a fixing pin 82a.

According to the method of pivoting the upper footrest 40 using the connectors 82 according to the first embodiment, when the upper footrest 40 is moved upwards, the connecting portions 82b rotate using the fixing pins 82a as the axes so that the upper footrest 40 is folded upwards as illustrated in FIG. 9.

In addition, as illustrated in FIG. 7b, a second embodiment of the upper footrest pivoting means 80 according to the present disclosure includes connecting members 83. Each of the connecting members 83 includes an accommodating portion 83b formed in the rear portion thereof and extensions 83c provided on end portions of the accommodating portion to face each other. The accommodating portion 83b is configured to be coupled to the upper footrest fixing portion 21, and has a slit 83a formed in the central thereof such that a guide 83d of the upper footrest fixing portion 21 is fitted into the slit. The extensions 83c are configured to be fixed to the upper footrest 40.

According to the method of pivoting the upper footrest 40 using the connecting members 83 according to the second embodiment, when the upper footrest 40 is moved upwards, the connecting members 83 rotate using the upper footrest fixing portions 21 as the axes and, at the same time, the slits 83a are pivoted by being guided by the guides 83d. As a result, the upper footrest 40 is reliably folded upwards instead of being displaced.

In addition, as illustrated in FIG. 7c, a third embodiment of the upper footrest pivoting means 80 according to the present disclosure is implemented as pivot units 84 respectively including a fixed portion 84a on one side and a pivoting portion 84c on the other side. The fixed portion 84a is fixedly disposed on the upper footrest 40. The pivoting portion 84c extends through the upper footrest fixing portion by means of a fixing pin 84b in a pivotable manner.

According to the method of pivoting the upper footrest 40 using the pivot units 84 according to the third embodiment, when the upper footrest 40 is moved upwards, the pivoting portions 84c of the pivot units 84 pivot using the fixing pins 84b as the axis. As a result, the upper footrest 40 is reliably folded upwards instead of being displaced.

In addition, as illustrated in FIG. 7d, a fourth embodiment of the upper footrest pivoting means 80 according to the present disclosure is implemented as hinges 85 connecting the upper footrest 40 and the upper footrest fixing portion 21.

According to the method of pivoting the upper footrest 40 using the pivot units 84 according to the fourth embodiment, when the upper footrest 40 is moved upwards, the upper footrest 40 is reliably folded upwards instead of being displaced due to the hinges 85.

An operating member H is disposed on the upper footrest in order to help the user easily operate the upper footrest when operating the upper footrest 40 upwards.

The above-described upper footrest 40 according to the present disclosure includes an upper footrest support panel 41 fixed to the upper footrest fixing portion 21 and an upper footrest member 42 fixedly disposed on the upper footrest support panel 41. With this configuration, the upper footrest support panel 41 supports the upper footrest member 42. The upper footrest member 42 may have cushioning performance.

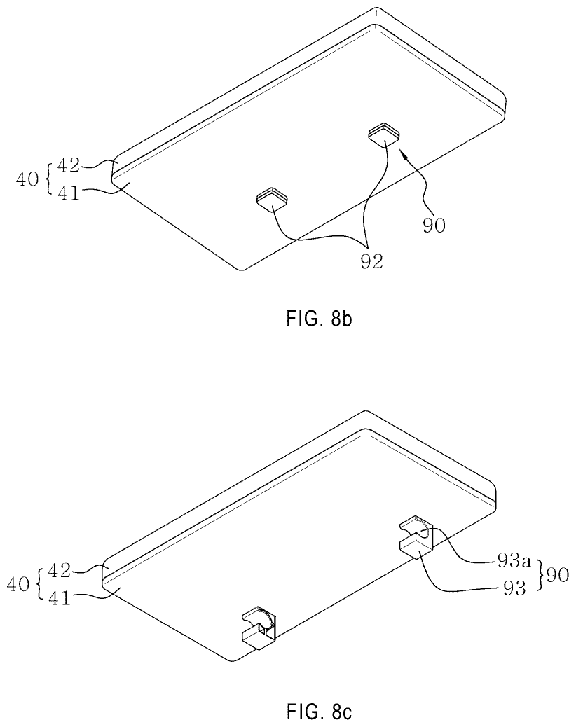

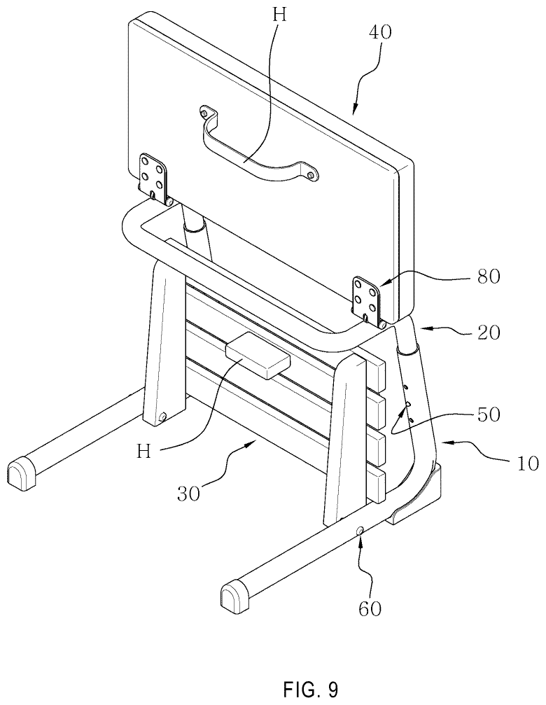

In addition, as illustrated in FIGS. 8a to 8c, an upper footrest angle changing means 90 is provided on the bottom of the upper footrest 40 according to the present disclosure. The upper footrest angle changing means is configured to change the angle of the upper footrest 40 by the contact of the lower end thereof with the upper footrest fixing portion 21. The angle of the upper footrest 40 may be changed depending on the body condition of the user so that the user may place his/her feet or calves at the most comfortable angle.

As illustrated in FIG. 8a, a first embodiment of the upper footrest angle changing means 90 operating as above is implemented as upper screw bolts 91 configured to adjust the distance between the upper footrest fixing portion 21 and the bottom of the upper footrest 40. The distance between the upper footrest 40 and the upper footrest fixing portion 21 is changed depending on the direction of rotation of the upper screw bolts 91, thereby changing the direction of inclination of the upper footrest 40.

As illustrated in FIG. 8b, a second embodiment of the upper footrest angle changing means 90 is implemented as spacers 92 configured to adjust the distance between the upper footrest fixing portion 21 and the bottom of the upper footrest 40. The distance between the upper footrest 40 and the upper footrest fixing portion 21 is changed depending on the height of the spacers 92, thereby changing the direction of inclination of the upper footrest 40.

In addition, as illustrated in FIG. 8c, a third embodiment of the upper footrest angle changing means 90 is implemented as polygonal lower eccentric rotation members 93. Each of the polygonal lower eccentric rotation members 93 has a fitting recess 93a into which the upper footrest fixing portion 21 is tightly fitted so that the distance between the upper footrest fixing portion 21 and the bottom of the upper footrest 40 is adjusted. The distance between the upper footrest 40 and the upper footrest fixing portion 21 is changed depending on the direction of rotation of the lower eccentric rotation members 93, thereby changing the direction of inclination of the upper footrest 40.

The above-described upper footrest angle changing means 90 may be disposed at the bottom and rear position of the upper footrest 40. Due to this configuration, the angle of inclination between the front portion and the rear portion of the upper footrest 40 may be changed by adjusting the height of the bottom and rear portion of the upper footrest 40.

The polygonal lower eccentric rotation members 93 are used in the upper footrest angle changing means 90 in order to provide reliable supporting force by the contact of the top surfaces of the rotated lower eccentric rotation members 93 with the top surface of the upper footrest 40 in a position in which the lower eccentric rotation members 93 are rotated.

In addition, acupressure members M for applying pressure to or massaging the soles or calves are provided on the surface of at least one of the lower and upper footrests 30 and 40. The acupressure members M may apply pressure to or massage the soles or calves placed on at least one of the lower and upper footrests 30 and 40.

In addition, the lower and upper footrests 30 and 40 are configured such that when the lower and upper footrests 30 and 40 are folded upwards, the folded lower and upper footrests 30 and 40 are inclined downward in the top to bottom direction. Due to this configuration, when the lower and upper footrests 30 and 40 according to the present disclosure are folded upwards as illustrated in FIG. 9, accidental unfolding of the lower and upper footrests as illustrated in FIGS. 3 and 4 is prevented.

Each of the distances to the rear ends of the lower and upper footrest fixing portions 11 and 21 from the pivoting points of the lower and upper footrest pivoting means 60 and 80 of the lower and upper footrests 30 and 40 disposed on the lower and upper footrest fixing portions 11 and 21 in order to prevent accidental unfolding of the upwardly-folded lower and upper footrests 30 and 40 as described above is set to be greater than the thickness of the lower and upper footrests 30 and 40.

As described in the above in the Advantageous Effects section, the two-stage foot support device having the above-described configuration according to the present disclosure may be located in front of a chair under a desk or a variety of tables to allow a user to place his/her feet or calves on the device so as to work or take a rest in a comfortable position. The angle of an upper or lower footrest may be adjusted as required to an angle at which the user may feel comfortable. When the upper footrest is not used, the upper footrest may be folded upwards, and the upper footrest may be continuously maintained in the folded position so as not to be accidently unfolded from the folded position. In addition, the upper and lower footrests may be provided on the upper and lower footrest support means, respectively, so as to be selectively used.

1. A two-stage foot support device located on an indoor floor in front of a chair under a desk or a table to allow a user to place his/her feet or calves on the device so as to work or take a rest in a comfortable position, the two-stage foot support device comprising: a lower footrest support means provided at a lower position, with a lower footrest being disposed thereon; and an upper footrest support means provided above the lower footrest support means, with an upper footrest being disposed thereon,
wherein the lower footrest support means has an “L” shaped cross-section when viewed from a side, braces are pivotably disposed on both sides of a bottom of the L-shaped lower footrest support means, the lower footrest having a slope inclined downward from the rear to the front is disposed on the braces, thereby allowing the feet to be comfortably placed on the lower footrest and the lower footrest to be folded or unfolded for use, and the lower footrest support means comprises lower footrest fixing portions inclined downward in a top to bottom direction and lower coupling portions provided on both rear ends of the lower footrest fixing portions to extend upward such that the lower footrest is prevented from being accidently unfolded once folded upwards, and
wherein the upper footrest support means is shaped as “U” when viewed from above and the Korean letter “¬” when viewed from a side, an upper footrest is pivotably disposed on the U-shaped top of the upper footrest support means so that the upper footrest is foldable or unfoldable for use, and comprises an upper footrest fixing portion inclined downward in a top to bottom direction and upper coupling portions provided on both the rear ends of the upper footrest fixing portion to extend upward such that the upper footrest is prevented from being accidently unfolded once folded upwards.

2. The two-stage foot support device of claim 1, wherein the lower and upper footrest support means are integrally connected to each other.

3. The two-stage foot support device of claim 1, wherein the lower and upper footrest support means are configured to be detachably connected to each other such that the upper footrest support means on which the upper footrest is disposed is height-adjustable with respect to the lower footrest support means on which the lower footrest is disposed, thereby adjusting the distance between the lower and upper footrests.

4. The two-stage foot support device of claim 1, wherein each of the lower and upper footrest support means comprises a hollow circular or angled frame.

5. The two-stage foot support device of claim 1, wherein the lower and upper footrest support means are height-adjustable due to the upper and lower coupling portions coupled in a slidable manner and, once adjusted in heights, are fixed at the adjusted heights.

6. The two-stage foot support device of claim 5, wherein the fixing means comprises a stopper provided on each of the lower or upper coupling portions and holes provided in each of the upper or lower coupling portions in a longitudinal direction such that when the stopper is aligned with one of the holes, the stopper is fitted into the hole.

7. The two-stage foot support device of claim 1, wherein protection members are disposed on the bottom of the lower footrest support means.

8. The two-stage foot support device of claim 1, wherein the lower footrest comprises the braces fixed to the lower footrest support means and a plurality of horizontal bars disposed on the braces.

9. The two-stage foot support device of claim 1, wherein a lower footrest pivoting means for pivoting the lower footrest is disposed between the lower footrest support means and the lower footrest.

10. The two-stage foot support device of claim 9, wherein the lower footrest pivoting means comprises center pins extending through the lower footrest and the lower footrest fixing portions.

11. The two-stage foot support device of claim 1, wherein the lower footrest is configured such that the thickness of each of the braces gradually decreases in a direction from the rear to the front adjacent to the chair such that the lower footrest has a slope surface inclined downward from the rear to the front.

12. The two-stage foot support device of claim 1, wherein a lower footrest angle changing means is disposed on a lower portion of the lower footrest to change the angle of the lower footrest by contact of the lower end of the lower footrest angle changing means with the lower footrest fixing portions.

13. The two-stage foot support device of claim 12, wherein the lower footrest angle changing means comprises lower screw bolts configured to change the angle of the lower footrest by adjusting distances between the lower footrest fixing portions and the lower portion of the lower footrest.

14. The two-stage foot support device of claim 12, wherein the lower footrest angle changing means comprises polygonal lower eccentric rotation members configured to change the angle of the lower footrest by adjusting distances between the lower footrest fixing portions and the lower portion of the lower footrest.

15. The two-stage foot support device of claim 1, wherein an upper footrest pivoting means for pivoting the upper footrest is provided between the upper footrest support means and the upper footrest.

16. The two-stage foot support device of claim 15, wherein the upper footrest pivoting means comprises connectors respectively comprising a connecting portion, with one side thereof being fixed to the upper footrest and the other side thereof being pivotably disposed on the upper footrest fixing portion by means of a fixing pin.

17. The two-stage foot support device of claim 15, wherein the upper footrest pivoting means comprises connecting members respectively comprising an accommodating portion having a slit formed in a central thereof, to which the upper footrest fixing portion is coupled, and extensions provided on end portions of the accommodating portion to face each other and fixed to the upper footrest.

18. The two-stage foot support device of claim 15, wherein the upper footrest pivoting means comprises pivot units respectively comprising a fixed portion on one side and a pivoting portion on the other side, the fixed portion being fixedly disposed on the upper footrest, and the pivoting portion extending through the upper footrest fixing portion by means of a fixing pin in a pivotable manner.

19. The two-stage foot support device of claim 15, wherein the upper footrest pivoting means comprises a hinge connecting the upper footrest and the upper footrest fixing portion.

20. The two-stage foot support device of claim 1, wherein the upper footrest comprises an upper footrest support panel located at a lower position and an upper footrest member fixedly disposed on the upper footrest support panel.

21. The two-stage foot support device of claim 1, wherein an upper footrest angle changing means for changing the angle of the upper footrest by contact of the lower end thereof with the upper footrest fixing portion is provided on a bottom of the upper footrest.

22. The two-stage foot support device of claim 21, wherein the upper footrest angle changing means comprises upper screw bolts disposed on the bottom of the upper footrest to adjust the distance between the upper footrest fixing portion and the bottom of the upper footrest depending on the direction of rotation.

23. The two-stage foot support device of claim 21, wherein the upper footrest angle changing means comprises spacers disposed on the bottom of the upper footrest to adjust the distance between the upper footrest fixing portion and the bottom of the upper footrest.

24. The two-stage foot support device of claim 21, wherein the upper footrest angle changing means comprises a polygonal lower eccentric rotation member having a fitting recess into which the upper footrest fixing portion is fitted in a pivotable manner.

25. The two-stage foot support device of claim 1, wherein operating members are disposed on bottoms of the lower and upper footrests, respectively, each of the operating members being configured to help a corresponding one of the lower and upper footrests to return to an original position or to be pivoted and folded upwards from the original position.

26. The two-stage foot support device of claim 1, wherein acupressure members for applying pressure to or massaging the soles or calves are provided on a surface of at least one of the lower and upper footrests.
